(19) United States
(12) Patent Application Publication
(10) Pub. No.: US 2025/0016053 A1
(43) Pub. Date: Jan. 9, 2025

(54) APPLICATION MANAGEMENT IN MOBILE COMMUNICATION NETWORKS

(71) Applicant: Telecom Italia S.p.A., Milano (IT)

(72) Inventors: Gian Michele DELL' AERA, Torino (IT); Andrea BULDORINI, Torino (IT); Enrico GUARINO, Torino (IT)

(73) Assignee: Telecom Italia S.p.A., Milano (IT)

(21) Appl. No.: 18/710,623

(22) PCT Filed: Oct. 19, 2022
(86) PCT No.: PCT/EP2022/079117

§ 371 Date: May 16, 2024

(30) Foreign Application Priority Data
Nov. 29, 2021 (IT) 102021000030140

(51) Int. Cl. H04L 41/0894

(52) U.S. Cl. CPC H04L 41/0894

(57) ABSTRACT

A mobile communication network comprising a plurality of radio network nodes; a service manager orchestrator module configured to handle network service and operation and configuration of the radio network nodes by generating requests requesting policies for the management of said radio network nodes; a controller platform configured to manage the radio network nodes by controlling the execution of applications for carrying out tasks on the radio network nodes according to policies requested by the service manager orchestrator module through the requests. The controller platform comprises: a database module configured to store configuration data comprising data about the configuration and status of said tasks and of said applications; a data buffer module configured to manage data communication among the applications, the service manager orchestrator module and the radio network nodes; a control system configured to manage the lifecycle of the applications by controlling the data buffer based on said configuration data.

### BACKGROUND OF THE PRESENT INVENTION

### Field of the Present Invention

The present invention generally relates to the communication network field. More particularly, the present invention relates to a mobile communication network having Self-Organizing Network (“SON”) capabilities.

### Overview of the Related Art

Modern mobile communication networks, such as 4G, 5G mobile communication networks, are capable of implementing Self-Organizing Network (“SON”) capabilities for the automatic configuration and management of network nodes of the mobile communication network.

Among the known architectures for implementing SON capabilities in a mobile communication network, the one described in the White Paper “O-RAN Use Cases and Deployment Scenarios, Towards Open and Smart RAN”, February 2020, by the O-RAN Alliance (https://static1.squarespace.com/static/5ad774cce74940d7115044b0/t/5e95a0a306c6ab2d1cbca4d3/1586864301196/O-RAN+Use+Cases+and+Deployment+Scenarios+Whitepaper+February+2020.pdf), provides for:
a Service Manager Orchestrator (SMO) configured to handle the network service and configurations, by generating requests of specific policies/services for the management of the network nodes;
one or more near Real Time Radio Intelligent Controllers (“nRT-RIC”, hereinafter referred to as “controller platforms”) configured to collect information from the network nodes and, exploiting Machine Learning (IL) and/or Artificial Intelligence (AI) engines, control the network nodes in order to carry out tasks on the network nodes exploiting the policies requested by the SMO through the generated requests.

Each controller platform is a platform node of the mobile communication network where multiple applications (hereinafter referred to as “xAPPs”) can run concurrently, each one for carrying out a corresponding task. Through the ML and/or AI engines, the controller platform can efficiently control the execution of the xAPPs for performing a variety of tasks, regarding for example (the list being not exhaustive):
The monitoring of potentials network faults;
The handling of Quality of Experience (QoE);
The handling of Quality of Service (QoS);
The handling of network traffic balance;
The handling of network interference.

The controller platform is interfaced with the SMO and with (e.g., a respective set of) the network nodes through proper interfaces.

A first interface, referred to as “A1 interface” between the SMO and the controller platform is configured to be exploited by the SMO for forwarding requests regarding mobile communication networks operation policies to the controller platform.

A second interface, referred to as “E2 interface” between the controller platform and (e.g., the respective set of) the network nodes, is configured to be used for receiving information collected from the network nodes and for providing control messages for controlling (e.g., the respective set of) the network nodes according to the policies requested by the SMO.

A third interface, referred to as “O1 interface” between the SMO and the controller platform is configured to be used to monitor the xAPPs lifecycles and the controller platform, and to configure the controller platform.

US patent application US2021029580 discloses various embodiments providing for flexible buffer management that optimize congestion control using radio access network (RAN) intelligent controller. According to some embodiments, a system can comprise monitoring a performance of a communication traffic flow using a group of buffer parameters of a network node device of a wireless network, wherein the performance is measured according to a defined performance criterion, receiving performance values for requested performance characteristics of the performance of the communication traffic flow via a first interface, and based on an adjustment value of the performance values, adjusting, via a second interface, a buffer parameter of the group of buffer parameters.

PCT application WO 2021/048831 discloses a method performed by a non-real time radio access network intelligent controller (NonRT-RIC) network node that comprises obtaining data for improving radio resource management (RRM) of a radio access network (RAN) and building an A1 interface message comprising one or more enrichment information (EI) elements based on the obtained data. Each of the one or more EI elements comprises an identifier of one or more wireless devices, a type indicator indicating a type of enrichment data included in the EI element, and the enrichment data. The method further comprises transmitting the AI interface message to a near real time radio access network intelligent controller (NearRT-RIC).

U.S. Pat. No. 10,791,467 discloses a framework of abstraction of new and existing 5G radios that can enhance capabilities of new and existing micro radios and other short range radio technologies to enable intelligent service delivery, dynamic access learning capability, and network slicing over 5G access networks. Enhancing layer communication for both control and user plane can be tunneled through the hosting layer and exploit a common transport provided by the hosting layer. The tunneling through the hosting layer can also enable the enhance capabilities to access the same radio management functions and can be orchestrated by the same core function. The framework for abstraction of the resources can be used to provide dynamic sharing of the resources and then be divided amongst different carriers.

### SUMMARY OF THE PRESENT INVENTION

Applicant has observed that none of the solutions known in the art is capable of managing the lifecycle of the xAPPs and the controller platform in an efficient way. Indeed, the solutions known in the art cannot efficiently manage the concurrent execution of a large number of xAPPs for carrying out different tasks, and especially the routing of messages and data among the SMO, the controller platform(s) and the network nodes through the various interfaces.

In view of the above, Applicant has devised a solution to efficiently manage the lifecycle of the xAPPs and the controller platform.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present that applies mutatis mutandis to any other aspect thereof).

An aspect of the present invention relates to a mobile communication network.

The mobile communication network comprises a plurality of radio network nodes.

The mobile communication network comprises a service manager orchestrator module configured to handle network service and operation and configuration of the radio network nodes by generating requests RQ requesting policies for the management of said radio network nodes.

The mobile communication network further comprise a controller platform configured to manage the radio network nodes by controlling the execution of applications for carrying out tasks on the radio network nodes according to policies requested by the service manager orchestrator module through the requests RQ.

The controller platform comprises a database module configured to store configuration data comprising data about the configuration and status of said tasks and of said applications.

The controller platform further comprises a data buffer module configured to manage data communication among the applications, the service manager orchestrator module and the radio network nodes.

The controller platform further comprises a control system configured to manage the lifecycle of the applications by controlling the data buffer based on said configuration data.

In this way, even if a plurality of different applications are concurrently running, messages and data can be efficiently routed among the service manager orchestrator module, the controller platform and the network nodes, through the data buffer.

According to an embodiment of the present invention, said configuration data comprises, for each one of said tasks, at least one among:
a task type parameter indicative of a purpose of said task;
a task priority parameter indicative of a priority of said task;
an application list listing the applications involved for carrying out said task.

According to an embodiment of the present invention, said configuration data comprises, for each one of said applications, at least one among:
an application identification parameter identifying the application;
an application policy parameter identifying policies supported by the application;
an application status parameter identifying a status of the application.

According to an embodiment of the present invention, said configuration data further comprises data about the configuration and status of the controller platform.

According to an embodiment of the present invention, said configuration data comprises at least one between:
a controller platform identification parameter identifying the controller platform;
a controller platform status parameter identifying a status of the controller platform.

According to an embodiment of the present invention, said control system comprises a manager module configured to receive from the service manager orchestrator module a request to set a policy for the operation of at least one application involved in the carrying out of a task.

According to an embodiment of the present invention, said manager module is further configured to provide said request to the data buffer module.

According to an embodiment of the present invention, said manager module is further configured to cause said request to be forwarded to said at least one application through the data buffer module by controlling said data buffer module based on said configuration data.

According to an embodiment of the present invention, said manager module is configured to forward said request to said at least one application by controlling said data buffer module based at least on the application policy parameter corresponding to said at least one application.

According to an embodiment of the present invention, each application is configured to generate a node control message to be forwarded to selected radio network nodes so as to carry out a task on said selected network nodes.

According to an embodiment of the present invention, each application is configured to provide said control message to the data buffer module.

According to an embodiment of the present invention, said control system comprises a management and conflict module configured to forward said node control message to the selected radio network nodes through the data buffer module by controlling said data buffer module based on said configuration data.

According to an embodiment of the present invention, the management and conflict module is configured to control the data buffer module so that, when at least two applications are concurrently providing node control messages to the data buffer module, the node control messages are actually forwarded to the selected radio network nodes based on a comparison of the task priority parameters of the tasks involving said at least two applications.

According to an embodiment of the present invention, the controller platform is configured to control the data buffer module to collect from the radio network nodes information data regarding the status of the radio network nodes and to make said collected information data available to the applications that are currently running.

According to an embodiment of the present invention, the service manager orchestrator module comprises an orchestrator module configured to update/modify said configuration data for reconfiguring the controller platform.

According to an embodiment of the present invention, said tasks comprises at least one among:
a task directed to monitoring potentials network faults;
a task directed to handle Quality of Experience;
a task directed to handle Quality of Service;
a task directed to handle network traffic balance;
a task directed to handle network interference.

According to an embodiment of the present invention, said mobile communication network is a 4G or a 5G mobile communication network configured to implement Self-Organizing Network capabilities.

Another aspect of the present invention relates to a method for managing a mobile communication network including a plurality of radio network nodes.

The method comprises handling network service and operation and configuration of the radio network nodes by generating requests requesting policies for the management of said radio network nodes.

The method further comprises managing the radio network nodes by controlling the execution of applications for carrying out tasks on the radio network nodes according to policies requested through the requests.

Said managing the radio network nodes comprises storing configuration data comprising data about the configuration and status of said tasks and of said applications.

Said managing the radio network nodes further comprises managing, through data buffering, data communication between the applications and the radio network nodes, and communication of the requests to the applications,

Said managing the radio network nodes further comprises managing the lifecycle of the applications by controlling the data buffering based on said configuration data.

### BRIEF DESCRIPTION OF THE DRAWINGS

These and other features and advantages of the present invention will appear more clearly by reading the following detailed description of exemplary and non-limitative embodiments thereof. For its better intelligibility, the following description should be read making reference to the attached drawing, wherein:

FIG. 1 is a schematic representation of a mobile communication network according to an embodiment of the present invention;

FIG. 2 depicts a flow chart showing in terms of functional blocks a lifecycle of applications managed by the controller platform of the mobile communication network of FIG. 1 according to an embodiment of the present invention.

FIG. 3 schematically illustrates in greater detail operation phases carried out by the SMO controller module, by the orchestrator module, and by the controller platform of the mobile communication network of FIG. 1 according to an exemplary embodiment of the present invention.

### DETAILED DESCRIPTION OF EXEMPLARY AND NON-LIMITATIVE EMBODIMENTS OF THE PRESENT INVENTION

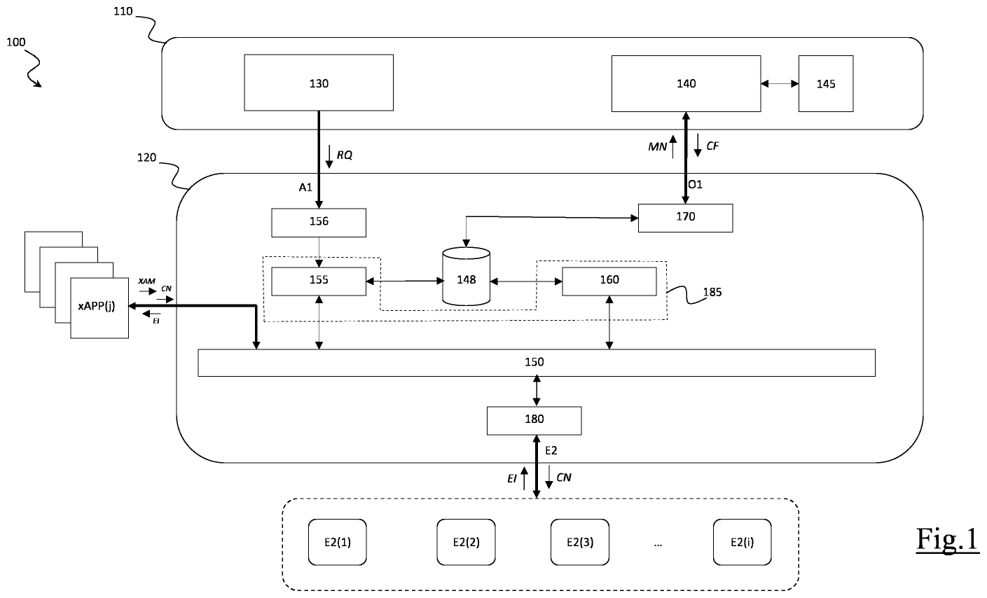

With reference to the drawing, FIG. 1 is a schematic representation of a mobile communication network 100 according to an embodiment of the present invention.

It has to be appreciated that in the present description, the terms “nodes”, “module”, “platform” and “unit” are intended to emphasize functional (rather than implementation) aspects thereof. Each node/module/platform/unit of the mobile communication network 100 which will be described herein may be implemented by software, hardware, and/or a combination thereof. Moreover, some of the nodes, modules, platforms and units may also reflect, at least conceptually, physical structures of portions of the mobile communication network 100.

The mobile communication network 100 comprises a plurality of network nodes E2(i) (i=1, 2, . . . ), e.g., radio network nodes such as eNodeB and/or gNodeB base stations.

According to an embodiment of the present invention, the mobile communication network 100 is a 4G or a 5G mobile communication network (however, the concepts of the inventions can be applied to any other mobile communication network, such as based on future development of 4G/5G) configured to implement SON capabilities, and its architecture is compliant with the O-RAN alliance architecture described in the already mentioned White Paper “O-RAN Use Cases and Deployment Scenarios, Towards Open and Smart RAN”.

According to an embodiment of the present invention, the mobile communication network 100 comprises a Service Manager Orchestrator (SMO) module 110 configured to handle the network service and the operation and configuration of the network nodes E2(i) by generating request RQ messages requesting specific policies/services for the management of said network nodes E2(i).

According to an embodiment of the present invention, the mobile communication network 100 further comprises at least one controller platform 120 (only one illustrated in FIG. 1) configured to collect information data EI from the network nodes E2(i) and manage the network nodes E2(i) by controlling the execution of applications xAPP(j) for carrying out specific tasks TSK(k) on the network nodes E2(i) according to the policies requested by the SMO module 110 through the request messages RQ.

According to an embodiment of the present invention, the controller platform 120 is interfaced with the SMO module 110 through an A1 interface (identified in figure with reference A1) for receiving the request messages RQ from the SMO 110.

According to an embodiment of the present invention, the controller platform 120 is further interfaced with the SMO module 110 through an O1 interface (identified in figure with reference O1) for:
receiving configuration messages CF from the SMO 110 directed to the (re)configuration of the controller platform 120 itself;
sending monitoring messages MN to the SMO 110 providing information about the lifecycles of the applications xAPP(j) and about the controller platform 120.

According to an embodiment of the present invention, the controller platform 120 is interfaced with the network nodes E2(i) through an E2 interface (identified in figure with reference E2) for receiving information data EI from the network nodes E2(i) regarding the status of the network nodes E2(i), and for providing to the latter node control messages CN for carrying out tasks TSK(k) implemented by applications xAPP(j) running according to the policies requested by the SMO module 110.

In the embodiment of the invention illustrated in FIG. 1, only one controller platform 120 is provided, directed to interact with all the network nodes E2(i) of the mobile communication network 100. However, similar considerations apply in case a plurality of controller platforms 120 are provided, each one configured to collect information from and to send control messages to a corresponding set of network nodes E2(i). System redundancy can be also possible, with two or more controller platforms 120 that are directed to interact with same network nodes E2(i).

According to an embodiment of the present invention, the SMO module 110 comprises a non-real time controller module 130 (hereinafter, “SMO controller module”) configured to generate the request messages RQ indicative of requests of specific policies/services for the management of selected network nodes E2(i).

According to an embodiment of the present invention, the SMO module 110 further comprises a network function orchestrator module 140 (hereinafter, “orchestrator module”) configured to generate the configuration messages CF for the (re)configuration of the controller platform 120. For example, the configuration messages CF can be generated by a user of the orchestrator module 140, for example through a corresponding Graphic User Interface (GUI) module 145. According to an embodiment of the present invention, the orchestrator module 140 is further configured to collect from the controller platform 120 the monitoring messages MN providing information about the lifecycles of the applications xAPP(j) and about the controller platform 120. According to an embodiment of the present invention, the monitoring messages MN can be inspected by a user of the orchestrator module 140 through the GUI module 145.

According to an embodiment of the present invention, the controller platform 120 comprises a database module 148 configured to store configuration data CD of the controller platform 120. As will be described in detail in the following, the configuration data CD comprise data regarding the general configuration and status of the controller platform 120, as well as data about the configuration and status of tasks TSK(k) carried out by applications xAPP(j) and of the applications xAPP(j). According to an embodiment of the present invention, the configuration data CD may be updated/modified by the network function orchestrator module 140 according to the configuration messages CF and/or by the SMO controller module 130 according to the request messages RQ, and/or through application management messages XAM sent by the applications xAPP(j) and comprising information about the applications xAPP(j) (for example, name, software version, topic, status).

According to an embodiment of the present invention, the controller platform 120 comprises a data buffer module 150 operating as a messaging infrastructure for routing messages among the applications xAPP(j), the SMO module 110 and the network nodes E2(i), as will be described in greater detail in the following.

According to an embodiment of the present invention, the data buffer module 150 is arranged to provide a low-latency message (and data) delivery service among internal endpoints of the controller platform 120.

According to an embodiment of the present invention, the data buffer module 150 supports discovery of endpoints and registration of discovered endpoints. According to an embodiment of the present invention, the data buffer module 150 is also configured to remove registered endpoints.

According to an embodiment of the present invention, messages and data routing by the data buffer module 150 is managed by corresponding Application Programming Interfaces (APIs), allowing multiple messaging modes, such as a point-to-point messaging mode (e.g., for communication among endpoints of the data buffer module 150) and a publish/subscribe messaging mode (e.g., for sending information data EI collected from network nodes E2(i) to multiple applications xAPP(j)).

According to an embodiment of the present invention, the data buffer module 150 is configured to support message robustness to avoid data loss during an outage/restart of the data buffer module 150 or to release resources from the data buffer module 150 once a message is outdated.

According to an embodiment of the present invention, the controller platform 120 comprises an A1 manager module 155 coupled to the interface A1 through an A1 termination module 156 for receiving the request messages RQ and coupled to the data buffer module 150 for accordingly forward the received request messages RQ to selected applications xAPP(j) through the data buffer module 150 based on the configuration data CD stored in the database module 148, as will be described in greater detail in the following.

As will be described in the following, according to an embodiment of the present invention, the A1 manager module 155 is also configured to update/modify the configuration data CD stored in the database module 148 through the request messages RQ sent by the SMO controller module 130.

According to an embodiment of the present invention, the controller platform 120 further comprises a management and conflict module 160 coupled to the data buffer module 150 and to the database module 148 and configured to receive the application management messages XAM from the applications xAPP(j) through the data buffer module 150, and use them to further update/modify the configuration data CD stored in the database module 148.

According to an embodiment of the present invention, the applications xAPP(j) are configured to exploit information obtained by the information data EI and generate node control messages CN to be forwarded to selected network nodes E2(i) so as to carry out specific tasks TSK(k) on said selected network nodes E2(i) by running applications xAPP(j) according to the policies requested by the SMO module 110 through the request messages RQ. As will be described in detail in the following, the forwarding of the node control messages CN to the correct selected network nodes E2(i), as well as the management of possible conflicts among node control messages CN generated by concurrently running applications xAPP(j) is carried out through the data buffer module 150 under the control of the management and conflict module 160 based on the configuration data CD stored in the database module 148.

According to an embodiment of the present invention, the controller platform 120 further comprises a configuration server module 170 coupled between the interface O1 and the database module 148.

According to an embodiment of the present invention, the configuration server module 170 is configured to receive the configuration messages CF from the orchestrator module 140 and accordingly update/modify the configuration data CD stored in the database module 148.

According to an embodiment of the present invention, the configuration server 170 is also configured to inspect the database module 148 when the configuration data CD stored therein is modified, so as to assess the modifications on the stored configuration data CD. For example, according to an embodiment of the present invention, the configuration server 170 is configured to store an image of the content of the database module 148, that is updated when modifications on the configuration data CD are assessed.

According to an embodiment of the present invention, a user of the orchestrator module 140 may request the configuration server 170 to send information about the status of applications xAPP(j) and/or about the controller platform 120 through the GUI module 145. In response to said request, the configuration server 170 checks the stored image of the content of the database module 148, and accordingly generates and sends to the orchestrator module 140 monitoring messages MN providing the requested information about the status of applications xAPP(j) and/or about the controller platform 120.

According to an embodiment of the present invention, the data buffer module 150 is coupled to the network nodes E2(i) through a E2 termination module 180 for forwarding the node control messages CN generated by the applications xAPP(j) to the selected network nodes E2(i) and for providing information data EI collected from the network nodes E2(i) to the applications xAPP(j) under the control of the management and conflict module 160 by exploiting the configuration data CD stored in the database module 148.

In view of the above, the controller platform 120 according to the embodiments of the invention is advantageously provided with a control system 185, comprising the A1 manager module 155 and the management and conflict module 160, adapted to effectively manage the lifecycle of the applications xAPP(j) by efficiently controlling the data buffer module 150. For example, as will be described in greater detail in the following, the control system 185 according to embodiments of the present invention is configured to efficiently manage:
the forwarding of policies (requested through the request messages RQ) to selected applications xAPP(j) through an efficient control of the data buffer module 150 implemented by the A1 manager module 155 exploiting the configuration data CD stored in the database module 148, and
the forwarding of node control messages CN generated by specific applications xAPP(j) to selected network nodes E2(i) through an efficient control of the data buffer module 150 implemented by the management and conflict module 160 exploiting the configuration data CD stored in the database module 148.

As previously mentioned, according to an embodiment of the present invention, the configuration data CD stored in the database module 148 comprises a list of data/parameters about the configuration and management of the controller platform 120, and about the configuration and status of tasks TSK(k) carried out by the applications xAPP(j) and of the applications xAPP(j) themselves.

According to an embodiment of the present invention, the configuration data CD comprise a parameter Controller_ID identifying the controller platform 120. The parameter Controller_ID is particularly useful in case the mobile communication network 100 comprises a plurality of different controller platforms 120, such as for example a first controller platform 120 for the management of a first group of 4G network nodes E2(i), a second controller platform 120 for the management of a second group of 4G network nodes E2(i), a third controller platform 120 for the management of a group of 5G network nodes E2(i), a fourth controller platform 120 specifically configured for the management of radio control events only, and so on.

According to an embodiment of the present invention, the configuration data CD comprise a parameter Instructive_msg used to set a status indicative of the behavior of the controller platform 120 in the reconfiguration of network nodes E2(i) using node control messages CN. According to an embodiment of the present invention, the parameter Instructive_msg can be set to an “ON” value or to an “OFF” value. When the parameter Instructive_msg is set to “ON”, the controller platform 120 is allowed to send node control messages CN to the network nodes E2(i). When the parameter Instructive_msg is set to “OFF”, the controller platform 120 is prevented from sending node control messages CN to the network nodes E2(i). Additional values of the parameter Instructive_msg can be provided, such as for example a value “ON_ONLY_L3” to enable the controller platform 120 to send node control messages CN only for a Layer 3 protocol reconfiguration. The parameter Instructive_msg can also be used to enable system redundancy avoiding interference between two or more controller platforms 120 controlling a same set of network nodes E2(i). According to an embodiment of the present invention, when a new version of a controller platform 120 is deployed, its parameter Instructive_msg can be automatically set to “OFF” for a predetermined time.

According to an embodiment of the present invention, the configuration data CD comprise a list TaskList of the tasks TSK(k) that can be managed by the control platform 120. For each task TSK(k) of the list TaskList, the following is provided:
a parameter TaskType indicative of the purpose of the task TSK(k), such as for example monitoring of potentials network faults, handling of QoE, handling of QoS, handling of network traffic balance;
a parameter TaskPriority indicative of a priority (for example, an integer value) of the task TSK(k) to be used for resolving conflicts when applications xAPP(j) relating to different tasks TSK(k) are running concurrently;
a list xAPPList identifying the applications xAPP(j) involved for carrying out the task TSK(k) (the list xAPPList can be void or set to a null value if the task TSK(k) is not managed by the controller platform 120).

According to an embodiment of the present invention, the configuration data CD comprise a list xAPPListDescriptionList providing parameters describing each of the applications xAPP(j) involved in the tasks TSK(k) listed in the list TaskList (i.e., the applications xAPP(j) listed in the lists xAPPList of the controller platform 120). According to an embodiment of the present invention, for each application xAPP(j) listed in the lists xAPPList, the list xAPPListDescriptionList provides the following parameters:
a parameter xAPPId identifying the application xAPP(j);
a parameter xAPPName providing a name for the application xAPP(j) (this parameter can be also used to identify the application in addition to or in the place of the parameter xAPPId);
a parameter xAPPVersion identifying the software version of the application xAPP(j);
a parameter A1PolicySupported identifying which policies requested by the SMO module 110 can be handled by the application xAPP(j);
a parameter xAPPStatus identifying a status of the application xAPP(j) (e.g., “running”, “hold”, “crashed”), which can be modified by the SMO module 110;
a parameter xAPPVendor identifying the vendor of the application xAPP(j).

It is pointed out that the parameters listed above are only an example of the configuration data CD that can be exploited by the controller platform 120, and the concepts of the present invention can also be applied to cases in which the configuration data CD are different from the ones described above, provided that the configuration data CD comprise at least a list TaskList of the tasks TSK(k) that can be managed by the control platform 120, and a list xAPPListDescriptionList providing parameters describing each of the applications xAPP(j) involved in the tasks TSK(k) listed in the list TaskList.

According to an embodiment of the present invention, the configuration data CD can be stored in the database module 148 in form of a configuration file, for example in xml, yang, Json, or other suitable format.

An exemplary configuration file of the configuration data CD according to an embodiment of the present invention is provided hereinbelow (using the xml format).

```
<controllerPlatform xmlns=“urn:tim: controllerPlatform ”>
    <controller_id> 0 </controller_id>
    <instructive_msg> ON </instructive_msg>
  <TaskList>
    <TaskInfo>
        <taskType> Traffic Steering </TaskType>
        <taskPriority> 1 </ taskPriority >
      <xappList>
          <xapp_selected > ts_xapp </xapp_selected >
        <xapp_selected > generic_xapp </xapp_selected >
      </xappList>
      </TaskInfo>
    <TaskInfo>
          <taskType> QoS_QoE </TaskType>
          <taskPriority> 2 </taskPriority>
          <xappList>
          <xapp_selected > qos_xapp </xapp_selected >
          </xappList>
      </TaskInfo>
    <TaskInfo>
          <taskType> beam_optimization </TaskType>
          <taskPriority> 3 </taskPriority>
          <xappList>
            <xapp_selected > NONE </xapp_selected >
          </xappList>
    </TaskInfo>
    </TaskList>
    <xAppListDescription>
      <xAppInfo>
        <xAppId> 101 </xAppId>
        <xAppName> generic_xapp </xappName>
        <xAppTask> KPI collection </xappName>
        <A1PolicySupported>KPI</ A1PolicySupported>
        <xAppVendor>TIM</xAppVendor>
        <xAppVersion> 1.1 </xappName>
        <xAppStatus> running</xappName>
        ......
    </xAppInfo>
    <xAppInfo>
          <xAppId> 111 </xAppId>
        <xAppName> ts_xapp </xappName>
        <xAppTask> Traffic Steering </xappName>
        <A1PolicySupported>TS</ A1PolicySupported>
        <xAppVendor>Altran</xAppVendor>
        <xAppVersion> 2.1 </xappName>
        <xAppStatus> running </xappName>
        ......
    </xAppInfo>
      <xAppInfo>
          <xAppId> 103 </xAppId>
        <xAppName> beam_xapp </xappName>
        <xAppTask> beam collection </xappName>
        <A1PolicySupported>NONE</ A1PolicySupported>
        <xAppVendor>ERICSSON</xAppVendor>
        <xAppVersion> 1.3 </xappName>
        <xAppStatus> hold</xappName>
        .....
    </xAppInfo>
    <xAppInfo>
        <xAppId> 104 </xAppId>
        <xAppName> qos_xapp </xappName>
        <xAppTask> QoS_QoE </xappName>
        <A1PolicySupported>QoS</ A1PolicySupported>
        <xAppVendor>TIM</xAppVendor>
        <xAppVersion> 1.0 </xappName>
        <xAppStatus> running </xappName>
        ......
    </xAppInfo>
    </xAppListDescription>
</controllerPlatform >
```

In the exemplary xml configuration file of the configuration data CD listed above, all the information related to a block is contained inside <block name></block name>. For example, the information related to a task TSK(k) is contained inside <TaskInfo></TaskInfo>.

The exemplary xml configuration file described above shows for example three tasks TSK(k) that can be managed by the controller platform 120, i.e., a Traffic Steering task TSK(k) (TaskType: “Traffic Steering”), a Quality of Experience/Quality of Service task TSK(k) (TaskType: “QoS_QoE”) and beam optimization task TSK(k) (TaskType: “beam_optimization”). The Traffic Steering task TSK(k) is configured with priority 1 and is configured to be carried out by two applications xAPP(j) (the application xAPP(j) “ts_xapp” and the application xAPP(j) “generic_xapp”). The Quality of Experience/Quality of Service task TSK(k) is configured with priority 2 and is configured to be carried out by a single application xAPP(j) (the application xAPP(j) “qos_xapp”). The beam optimization task TSK(k) is configured with priority 3 but is configured to be a task TSK(j) that is not handled by the controller platform 120. In the considered example, the exemplary application xAPP(j) “ts_xapp” can be identified through the parameter xAPPId (equal to “111”) and/or the parameter xAPPName (equal to “ts_xapp”), has a software version xAPPVersion equal to 2.1, can handle policies A1PolicySupported of the “TS” kind, its current status xAPPStatus is “running”, and the vendor xAPPVendor is “Altran”.

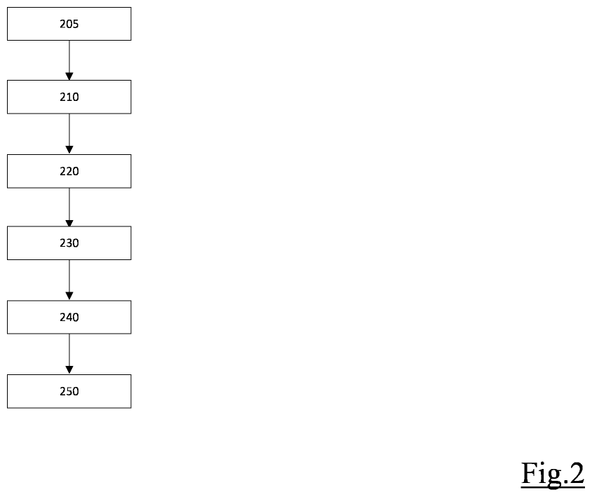

FIG. 2 depicts a flow chart showing in terms of functional blocks 205-250 a lifecycle of applications xAPP(j) managed by the controller platform 120 according to an embodiment of the present invention.

### Application Installation (Block 205)

According to an embodiment of the present invention, one or more applications xAPP(j) are installed in the controller platform 120. The installation procedure depends on the platform virtualization environment.

### Information Transmission Management (Block 210)

When an application xAPP(j) is installed, according to an embodiment of the present invention, it sends an application management message XAM comprising information describing the application xAPP(j). According to an embodiment of the present invention, the application management message XAM is collected by the data buffer module 150, and then the data buffer module 150 provides it to the management and conflict module 160. Then, the management and conflict module 160 accordingly updates the database 148 with the received application management message XAM in order to provide the database 148 with information about the application xAPP(j). According to an embodiment of the present invention, when an application xAPP(j) is installed, the application xAPP(j) is not operating yet, its status (identified by the parameter xAPPStatus) being set to “hold”. The operation of the application xAPP(j) is enabled by having its status (identified by the parameter xAPPStatus) switched from “hold” to “running” in response to a corresponding configuration message CF sent by the orchestrator module 140.

Since the data buffer module 150 according to an embodiment of the present invention is configured to collect from the network nodes E2(i) information data EI regarding the status of the network nodes E2(i), and the applications xAPP(j) have a direct access to the data buffer module 150, said information data EI are advantageously made available to all the application xAPP(j) that are currently running on the controller platform 120. In this way, all the applications xAPP(j) that are currently running on the controller platform 120 are advantageously aware of all the modifications occurred at the network nodes E2(i), and, when required for their operations, the applications xAPP(j) are able to easily collect the information data EI available on the data buffer module 150.

### Controller Platform Update by SMO Controller Module and Controller Platform Monitoring by the Management and Conflict Module 160 (Block 220)

According to an embodiment of the present invention, the information describing an application xAPP(j) contained in an application management message XAM received by the data buffer module 150 are collected by the management and conflict module 160, and then sent by the latter to the database module 148 for updating the configuration data CD relating to said application xAPP(j), and particularly the corresponding list xAPPListDescriptionList.

According to an embodiment of the present invention, the management and conflict module 160 may monitor the database module 148 for possible updates/modifications of the configuration data CD (for example the parameter Instructive_msg for changing a status of the controller platform 120) carried out by the SMO controller module 130 through request messages RQ collected by the A1 manager module 155.

### Controller Platform Update and Monitoring by User GUI (Block 230)

According to an embodiment of the present invention, the configuration server module 170 may monitor and inspect the configuration data CD stored in the database module 148, so as to expose to the orchestrator module 140 the configuration data CD (e.g., the xAPPListDescriptionList portion showing the status or configuration of running and/or newly installed applications xAPP(j)) through corresponding monitoring messages MN. For example, according to an embodiment of the present invention, a monitoring message MN comprising a subset of configuration data CD relating to a specific application xAPP(j) may be generated by the configuration server module 170 and sent to the orchestrator module 140 in response to a corresponding monitoring request regarding said specific application xAPP(j) carried out by a user of the orchestrator module 140, for example through the GUI module 145.

According to an embodiment of the present invention, the orchestrator module 140 (for example, under the control of a user, e.g., through the GUI module 145) may modify the configuration data CD stored in the database module 148 (for example, some parameters of one or more of the tasks TSK(k) listed in the list TaskList, or some parameters of one or more of the applications xAPP(j) listed in the list xAPPListDescriptionList) by sending corresponding configuration messages CF to the configuration server module 170. In this way, according to an embodiment of the present invention, the configuration server module 170 accordingly updates/modifies the proper portions of the configuration data CD stored in the database module 148 based on the received configuration messages CF.

### Policy Requests Management (Block 240)

According to an embodiment of the present invention, when the SMO controller module 130 sends a request message RQ to set a specific policy involving one or more applications xAPP(j), the controller platform 120 is able to identify said one or more involved application(s) xAPP(j) by exploiting the information contained in the database 148. According to an embodiment of the present invention, the A1 manager module 155 inspects the portion(s) of the configuration data CD stored in the database module 148 pertaining to said application(s) xAPP(j), such as the parameter A1PolicySupported included in the list xAPPListDescriptionList corresponding to said application(s) xAPP(j), and accordingly exploits the inspected configuration data CD to forward the request message RQ to the correct application(s) xAPP(j) through the data buffer module 150.

### Node Control Messages Management (Block 250)

According to an embodiment of the present invention, when an application xAPP(j) generates a node control message CN to be forwarded to selected network nodes E2(i) so as to carry out a specific task TSK(k) on said selected network nodes E2(i), said node control message CN is collected by the data buffer module 150. Then, under the control of the management and conflict module 160, and exploiting the portion(s) of the configuration data CD stored in the database module 148 pertaining to said task TSK(k) and to said application xAPP(j)—such as for example the parameter xAPPId—the data buffer module 150 forwards the node control message CN to the selected network nodes E2(i). According to an embodiment of the present invention, any conflict among different applications xAPP(j) is managed by the management and conflict module 160 based on the configuration data CD pertaining to the tasks TSK(k) carried out by said applications xAPP(j), such as for example exploiting the parameters TaskPriority of the involved tasks TSK(k).

According to an embodiment of the present invention, an application xAPP(j) sends a node control message CN by publishing it on the data buffer module 150 using a specific topic in order to allow the controller platform 120 to capture this message in the management and conflict module 160. Then, the node control message CN is forwarded to the E2 termination module 180 only if it is deemed appropriate according to the configuration data CD. According to an embodiment of the present invention, the E2 termination module 180 is listening for a control message CN from the data buffer module 150 to execute it in a reserved topic.

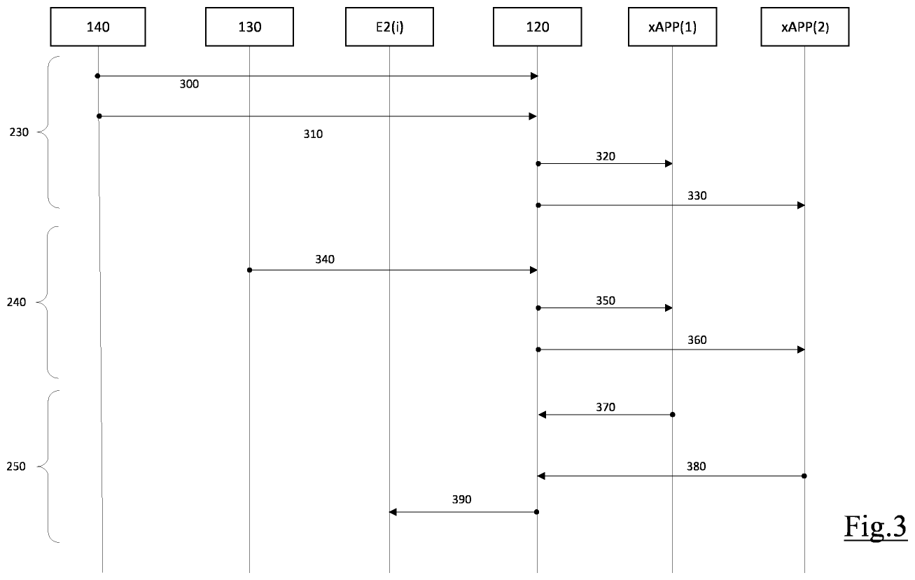

FIG. 3 schematically illustrates in greater detail a set of operation phases carried out by the SMO controller module 130, by the orchestrator module 140, and by the controller platform 120 relating to a portion of the lifecycle (corresponding to the functional blocks 230-250 of FIG. 2) of two exemplary applications xAPP(1), xAPP(2) according to an exemplary embodiment of the present invention.

The first phase according to an exemplary embodiment of the present invention provides for having the orchestrator module 140 get the status and the configuration of the controller platform 120 and of the applications xAPP(j) installed in the controller platform 120 (operation 300). For this purpose, according to an embodiment of the present invention, the orchestrator module 140 collects (e.g., a subset of) the configuration data CD stored in the database module 148 that have been exposed by the server module 170 through corresponding monitoring messages MN.

The next phase according to an exemplary embodiment of the present invention provides for having the orchestrator module 140 request the controller platform 120 to change the configuration of one or more tasks TSK(j) by requesting the modification of corresponding portions of the configuration data CD stored in the database module 148 by sending corresponding configuration messages CF to the configuration server module 170 of the controller platform 120 (operation 310). For example, the orchestrator module 140 may request to change the priority of a first task TSK(1) and of a second task TSK(2) (by properly modifying the corresponding parameters TaskPriority in the configuration data CD), or may assign the application xAPP(1) to the first task TSK(1), and the application xAPP(2) to the second task TSK(2) (by properly modifying the corresponding lists xAPPList in the configuration data CD). The modification of the configuration data CD regarding the first task TSK(1) may cause a modification of the status (parameter xAPPStatus) of the application xAPP(1) (operation 320) and the modification of the configuration data CD regarding the second task TSK(2) may cause a modification of the status (parameter xAPPStatus) of the application xAPP(2) (operation 330). For example, the parameters xAPPStatus of the applications xAPP(1) xAPP(2) are switched from “hold” to “running”.

It is pointed out that the operations 300-330 described above correspond to the functional block 230 of FIG. 2.

The next phase according to an exemplary embodiment of the present invention provides for having the SMO controller module 130 provide a set of policies to the controller platform 120 for the application xAPP(1) for carrying out task TSK(1) and for the application xAPP(2) for carrying out task TSK(2) (operation 340). For this purpose, the SMO controller module 130 sends a request message RQ of said set of policies to the A1 interface, that is collected by the manager module 155 of the controller platform 120. Then, the manager module 155 inspects the configuration data CD stored in the database module 148 in order to identify the applications xAPP(1) and xAPP(2). For example, based on the configuration data CD stored in the database module 148 pertaining to the task TSK(1), such as the information included in the list xAPPListDescriptionList corresponding to said task TSK(1) and the parameter A1PolicySupported corresponding to said application xAPP(1), the A1 manager module 155 forwards the set of policies to the application xAPP(1) (operation 350). Similarly, based on the configuration data CD stored in the database module 148 pertaining to the task TSK(2), such as the information included in the list xAPPListDescriptionList corresponding to said task TSK(2) and the parameter A1PolicySupported corresponding to said application xAPP(2), the A1 manager module 155 forwards the set of policies to the application xAPP(2) (operation 360).

It is pointed out that the operations 340-360 described above correspond to the functional block 240 of FIG. 2.

The next phase according to an exemplary embodiment of the present invention provides for having the application xAPP(1) send to the controller platform 120 a node control message CN (operation 370) to be forwarded to selected network nodes E2(i) so as to carry out the task TSK(1) on said selected network nodes E2(i) and having the application xAPP(2) send to the controller platform 120 a node control message CN (operation 380) to be forwarded to selected network nodes E2(i) so as to carry out the task TSK(2) on said selected network nodes E2(i). The control messages CN provided by the two applications xAPP(1), xAPP(2) are collected by (and published on) the data buffer module 150. The management and conflict module 160, exploiting the portion(s) of the configuration data CD pertaining to the task TSK(1)—such as its parameter TaskPriority—and pertaining to the application xAPP(1)—such as for example its parameter xAPPId —, and exploiting the portion(s) of the configuration data CD pertaining to the task TSK(2)—such as its parameter TaskPriority—and pertaining to the application xAPP(2)—such as for example its parameter xAPPId, manages the forwarding of the node control messages CN provided by the two applications xAPP(1), xAPP(2) to the corresponding selected network nodes E2(i) (operation 390). Particularly, according to an embodiment of the present invention, the management and conflict module 160 exploits the abovementioned portion(s) of the configuration data for deciding if both the node control messages CN provided by the two applications xAPP(1), xAPP(2) can be concurrently forwarded to the selected network nodes E2(i) without causing collisions, or only the node control message CN of one of the two applications xAPP(1), xAPP(2) can be transmitted in order to avoid collisions.

An example of management of a potential application collision by the management and conflict module 160 may provide for a case in which:
the application xAPP(1) has the parameter xAPPName equal to “ts_xapp”, and the task TSK(1) has the parameter TaskType equal to “Traffic Steering” and the parameter TaskPriority equal to “1”;
the application xAPP(2) has the parameter xAPPName equal to “qos_xapp”, and the task TSK(2) has the parameter TaskType equal to “QoS_QoE” and the parameter TaskPriority equal to “2”;
the node control message CN provided by the application xAPP(1) provides for asking the controller platform 120 to change a carrier frequency for a user equipment from 1800 MHz to 2600 MHz;
the node control message CN provided by the application xAPP(2) provides for asking the controller platform 120 to reserve 30 physical resource blocks for a user equipment.

The node control messages CN provided by the applications xAPP(1) and xAPP(2) are both published on the data buffer module 150. The management and conflict module 160 assesses that the task TSK(1) (Traffic Steering) has a higher priority than the task TSK(2) (QoS_QoE) by comparing the respective parameters TaskPriority, and therefore decides to take into account the task TSK(1) before the task TSK(2). In addition, the management and conflict module 160 assesses that the task TSK(2) depends on the carrier frequency.

In view of the above, the management and conflict module 160 assesses (in the following order) that:
the node control message CN provided by the application xAPP(1) can be forwarded to the selected network nodes E2(i), and
the control message CN provided by the application xAPP(2) cannot be forwarded to the selected network nodes E2(i) because, following the carrier frequency switch action caused by the control message CN provided by the application xAPP(1), the new value of the carrier frequency would be not compatible with the action requested by the control message CN provided by the application xAPP(2).

Therefore, the management and conflict module 160 controls the data buffer module 150 to send only the control message CN provided by the application xAPP(1) to the network nodes E2(i) through the E2 termination module 180.

The application xAPP(2) will then provide a second control message CN in a subsequent time calibrated on carrier frequency of 2600 MHz.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof, on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

More specifically, the present invention lends itself to be implemented through an equivalent method (by using similar steps, removing some steps being not essential, or adding further optional steps); moreover, the steps may be performed in different order, concurrently or in an interleaved way (at least partly).

1. A mobile communication network, comprising:
a plurality of radio network nodes;
a service manager orchestrator module configured to handle network service and operation and configuration of the radio network nodes by generating requests RQ requesting policies for the management of said radio network nodes;
a controller platform configured to manage the radio network nodes by controlling the execution of applications for carrying out tasks TSK(k) on the radio network nodes according to policies requested by the service manager orchestrator module through the requests, wherein the controller platform comprises:
a database module configured to store configuration data comprising data about the configuration and status of said tasks and of said applications;
a data buffer module configured to manage data communication among the applications, the service manager orchestrator module and the radio network nodes;
a control system configured to manage the lifecycle of the applications by controlling the data buffer based on said configuration data.

2. The mobile communication network of claim 1, wherein said configuration data comprises:
for each one of said tasks, at least one among:
a task type parameter indicative of a purpose of said task;
a task priority parameter indicative of a priority of said task;
an application list listing the applications involved for carrying out said task, and
for each one of said applications, at least one among:
an application identification parameter identifying the application;
an application policy parameter identifying policies supported by the application;
an application status parameter identifying a status of the application.

3. The mobile communication network of claim 1, wherein said configuration data CD further comprises data about the configuration and status of the controller platform.

4. The mobile communication network of claim 3, wherein said configuration data comprises at least one between:
a controller platform identification parameter identifying the controller platform;
a controller platform status parameter identifying a status of the controller platform.

5. The mobile communication network of claim 1, wherein said control system comprises a manager module configured to:
receive from the service manager orchestrator module a request to set a policy for the operation of at least one application involved in the carrying out of a task,
provide said request to the data buffer module, and
cause said request to be forwarded to said at least one application through the data buffer module by controlling said data buffer module based on said configuration data.

6. The mobile communication network of claim 5, wherein said manager module is configured to forward said request to said at least one application by controlling said data buffer module based at least on the application policy parameter corresponding to said at least one application.

7. The mobile communication network of claim 1, wherein:
each application is configured to generate a node control message to be forwarded to selected radio network nodes so as to carry out a task on said selected network nodes, each application being configured to provide said control message to the data buffer module;
said control system comprises a management and conflict module configured to forward said node control message to the selected radio network nodes through the data buffer module by controlling said data buffer module based on said configuration data.

8. The mobile communication network of claim 7, wherein the management and conflict module is configured to control the data buffer module so that, when at least two applications are concurrently providing node control messages to the data buffer module, the node control messages are actually forwarded to the selected radio network nodes based on a comparison of the task priority parameters of the tasks involving said at least two applications.

9. The mobile communication network of claim 1, wherein the controller platform is configured to control the data buffer module to collect from the radio network nodes information data regarding the status of the radio network nodes and to make said collected information data available to the applications that are currently running.

10. The mobile communication network of claim 1, wherein the service manager orchestrator module comprises an orchestrator module configured to update/modify said configuration data for reconfiguring the controller platform.

11. The mobile communication network of claim 1, wherein said tasks comprises at least one among:
a task directed to monitoring potentials network faults;
a task directed to handle Quality of Experience;
a task directed to handle Quality of Service;
a task directed to handle network traffic balance;
a task directed to handle network interference.

12. The mobile communication network of claim 1, wherein said mobile communication network is a 4G or a 5G mobile communication network configured to implement Self-Organizing Network capabilities.

13. A method for managing a mobile communication network including a plurality of radio network nodes, comprising;
handling network service and operation and configuration of the radio network nodes by generating requests requesting policies for the management of said radio network nodes;
managing the radio network nodes by controlling the execution of applications for carrying out tasks on the radio network nodes according to policies requested through the requests, wherein said managing the radio network nodes comprises:
storing configuration data comprising data about the configuration and status of said tasks and of said applications;
managing, through data buffering:
data communication between the applications and the radio network nodes, and
communication of the requests to the applications,
managing the lifecycle of the applications by controlling the data buffering based on said configuration data.
